(19) United States
(12) Patent Application Publication
(10) Pub. No.: US 2024/0141554 A1
(43) Pub. Date: May 2, 2024

(54) WICKERWORK FIBRE AND METHOD FOR THE PRODUCTION THEREOF

(71) Applicant: DEDON GmbH, Lüneburg (DE)

(72) Inventor: Nils KETTERING, Lüneburg (DE)

(21) Appl. No.: 18/494,100

(22) Filed: Oct. 25, 2023

(30) Foreign Application Priority Data
Oct. 26, 2022 (DE) 10 2022 128 285.6

(51) Int. Cl. D01D 5/253; D01D 5/30

(52) U.S. Cl. CPC D01D 5/253; D01D 5/30; D10B 2321/021; D10B 2503/00

(57) ABSTRACT

The application relates to a wickerwork fibre, in particular for the production of furniture and/or furniture parts, including a main body produced by extrusion and composed of a plastic material with a flat cross section, the width of which is a multiple of the height, and wherein the main body has elevations running parallel to one another at least on one broad side. In order to create a wickerwork fibre which closely resembles a natural fibre in terms of haptic and optical perception and can be produced in a simple manner, it is proposed that the elevations are triangular in cross section. The application also relates to a method for producing a wickerwork fibre of this kind.

### TECHNICAL FIELD

The invention relates to a wickerwork fibre, in particular for the production of furniture and/or furniture parts, including a main body produced by extrusion and composed of a plastic material with a flat cross section, the width of which is a multiple of the height, and wherein the main body has elevations running parallel to one another at least on one broad side. Furthermore, the invention relates to a method for producing such a wickerwork fibre.

### BACKGROUND

Wickerwork fibres of this kind are known from the production of weather-resistant outdoor furniture, for example. As a rule, the base material used for the production of these wickerwork fibres is a polyethylene, to which various substances are added to achieve the desired final properties, such as, in particular, UV resistance. In order to optically match these plastic fibres to the natural rattan wickerwork fibres, it is known in practice to provide at least the surface of the wickerwork fibres that is visible during use with a fibre structure.

DE 10 2015 000 034 B3 discloses a wickerwork fibre with webs running parallel to one another, which are spaced apart from one another by web interspaces, and wherein the width of the web interspaces has a certain relationship to the height of the webs. This known wickerwork fibre has proven itself in practice, but it is desirable to further improve its haptic and optical properties.

### SUMMARY

Based on this, the object of the invention is to create a wickerwork fibre which closely resembles a natural fibre in terms of haptic and optical perception and can be produced in a simple manner.

To achieve this object, the invention is characterized in that the elevations are triangular in cross section.

A wickerwork fibre which is configured with the elevations of triangular cross section according to the invention is characterized haptically by a pleasant surface structure that furthermore has good properties with regard to abrasion resistance. The visual impression made by the structure of the elevations, with a perception of the peaks of the individual elevations and the transitions from elevation to elevation which varies with the angle of view, is also reminiscent of a natural fibre with its varying surface structures. It is possible to achieve a great variation in the haptic and optical impression particularly also through the choice of the height of the triangular elevations.

According to one preferred embodiment of the invention, the triangular elevations are arranged directly adjacent to one another, in parallel, without any intermediate space. By directly lining up the triangular elevations immediately adjacent to one another, a particularly delicate surface structure can be produced.

To form the elevations, the proposal according to a preferred embodiment of the invention is that the two sides, forming the elevation, of the triangular elevations are of different lengths, i.e. that the triangle is not of isosceles design. This different side length of the sides forming the elevation results in different optical impressions, depending on the side from which the wickerwork fibre is viewed.

According to an alternative embodiment for the formation of the elevations, the two sides, forming the elevation, of the triangular elevations are of equal length.

To ensure that the wickerwork fibre makes a visually uniform overall impression, irrespective of the selected side length of the sides forming the elevation, it is furthermore proposed according to the invention that the two sides, forming the elevation, of the triangular elevations are of equal length on all elevations arranged adjacent to one another in parallel.

The invention furthermore proposes that elevations of triangular cross section are formed on both broad sides of the main body, thereby simplifying the processing of the wickerwork fibre since it is not necessary to pay attention to which side of the wickerwork fibre is oriented towards the finished surface.

According to a practical embodiment of the invention, it is proposed that the triangular elevations run in the longitudinal direction of the wickerwork fibre, very closely resembling a natural fibre profile of a natural fibre.

With an alternative embodiment of the invention, it is proposed that the triangular elevations are arranged at an angle that deviates from the longitudinal direction of the wickerwork fibre. With such an arrangement of the triangular elevations, it is possible to achieve different optical and haptic effects with the wickerwork fibre.

In order, in particular, to match the visual impression made by the wickerwork fibre according to the invention more closely to that of a natural fibre and at the same time to make the production of the wickerwork fibre relatively simple, the invention proposes that the two sides, forming the elevation, of each triangular elevation are formed by co-extruding two strands of plastic material, wherein the two strands of plastic material of the two sides forming the elevation are of different colours. In particular, a complementary contrast, such as red-green, has proven to be particularly close to nature and pleasant in terms of visual perception.

With the illustrative colour choice of a red side of the elevation and an opposite green side of the same elevation, there is, as a function of the angle of view of the observer, a continuous change in colour from red-green-striped when the wickerwork fibre is viewed in a directly perpendicular manner via a significant increase in the green component or the red component of the elevation, depending on the angle of view from the side.

In this configuration, this varying, continuous change in colour occurs only because of the fact that, according to the invention, the elevations are of triangular design in cross section, and it reminds the viewer of a natural fibre, where the perception of colour and surface structure also varies from angle of view to angle of view.

To produce the wickerwork fibre according to the invention, it is proposed in a first practical embodiment that the triangular elevations are formed by extrusion onto the flat main body.

According to an alternative embodiment, the invention proposes that the two sides, forming the elevation, of each triangular elevation are formed by co-extruding two strands of plastic material, wherein one of the two sides, forming the elevation, of each triangular elevation is formed integrally with the main body.

A first variant of the method according to the invention for producing a wickerwork fibre, of which the two sides, forming the elevation, of each triangular elevation, and the main body are produced by co-extrusion, is distinguished by the fact that the two sides, forming the elevation, of each triangular elevation are co-extruded from two strands of plastic material, wherein one of the two sides, forming the elevation, of each triangular elevation is formed integrally with the main body.

Finally, a second variant of the method according to the invention for producing a wickerwork fibre proposes that the two sides, forming the elevation, of each triangular elevation are co-extruded onto the main body from two separate strands of plastic material.

### BRIEF DESCRIPTION OF THE DRAWINGS

Further features and advantages of the invention will become apparent from the associated drawings, in which three exemplary embodiments of a wickerwork fibre according to the invention are illustrated purely by way of example, without restricting the invention to these exemplary embodiments. In the drawings:

FIG. 1 shows an enlarged perspective cross section through a segment of a wickerwork fibre according to the invention illustrating a first embodiment;

FIG. 2 shows a view according to FIG. 1, but illustrating a second embodiment of a wickerwork fibre according to the invention, and

FIG. 3 shows a view according to FIG. 1, but illustrating a third embodiment of a wickerwork fibre according to the invention.

### DETAILED DESCRIPTION

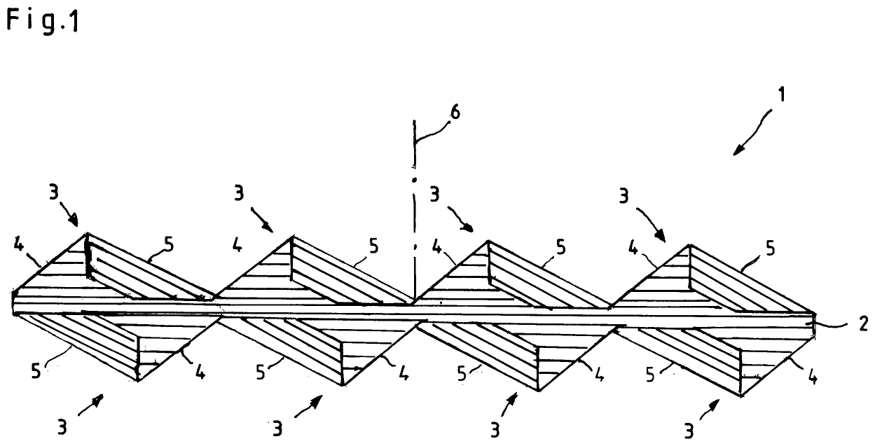

FIG. 1 to FIG. 3 of the drawings each show schematically in a cross section the structure of a wickerwork fibre 1.

Wickerwork fibres 1 of this kind are used, in particular, for producing furniture and/or furniture parts. However, it is also possible, for example, to produce wall coverings or sculptures from these wickerwork fibres 1.

The wickerwork fibres 1 described below include a main body 2 composed of a plastic material, preferably a polyethylene (PE), with a flat cross section, the width of which is a multiple of the height, and wherein the main body 2 has elevations 3 running parallel to one another on at least one broad side. The elevations 3 are likewise composed of a plastic material, preferably a polyethylene (PE).

In order to form such a wickerwork fibre 1 configured with elevations 3 in such a way that it is reminiscent of a natural fibre and is distinguished haptically by a pleasant surface structure that also has good properties with regard to abrasion resistance, the elevations 3 are triangular in cross section.

In the case of the wickerwork fibres 1 illustrated in the figures, the triangular elevations 3 are designed in such a way that the two sides 4 and 5 of the triangular elevations 3, which sides project from the main body 2 and form the elevation 3, are of different lengths. Of course, according to an alternative embodiment of the elevations 3, it is also possible and desirable for the two sides 4 and 5 forming the elevation 3 to be of equal length, i.e. to be of isosceles design.

The visual impression made by the structure of the triangular elevations 3, the perception of which changes according to the angle of view, is also reminiscent of a natural fibre with its varying surface structures.

In the embodiments shown in FIGS. 1 to 3, the elevations 3 are arranged in the direction of the longitudinal axis 6 of the main body 2, very closely resembling a natural fibre profile of a natural fibre.

Of course, it is also possible for the elevations 3 to be arranged at an angle that deviates from the direction of the longitudinal axis 6 of the main body 2. With such an arrangement of the elevations, it is possible to achieve different optical and haptic effects with the wickerwork fibre 1.

In order, in particular, to match the visual impression made by the wickerwork fibre 1 more closely to that of a natural fibre and at the same time to make the production of the wickerwork fibre 1 relatively simple, the two sides 4 and 5, forming the elevation 3, of each triangular elevation 3 are formed by co-extruding two strands of plastic material, wherein the two strands of plastic material of the two sides 4 and 5 forming each elevation 3 are of different colours. In particular, a complementary contrast, such as red-green, has proven to be particularly close to nature and pleasant in terms of visual perception.

With the illustrative colour choice of a red side 4 or 5 of the elevation 3 and an opposite green side 5 or 4 of the same elevation 3, there is, as a function of the angle of view of the observer, a continuous change in colour from red-green-striped when the wickerwork fibre 1 is viewed in a directly perpendicular manner via a significant increase in the green component or the red component of the elevation, depending on the angle of view from the side.

In this configuration, this varying, continuous change in colour is particularly clear only because of the fact that, according to the invention, the elevations 3 are of triangular design in cross section, and it reminds the viewer of a natural fibre, where the perception of colour and surface structure also varies from angle of view to angle of view.

In the first embodiment of a wickerwork fibre 1 illustrated in FIG. 1, the main body 2 has elevations 3 that run parallel to one another on both broad sides and are triangular in cross section, which are arranged directly adjacent to one another, in parallel, without any intermediate space.

The wickerwork fibre 1 illustrated in FIG. 1 is produced by co-extrusion in such a way that the two sides 4 and 5, forming the elevation 3, of each triangular elevation 3 are co-extruded from two separate strands of plastic material, wherein one of the two sides 4, forming the elevation 3, of each triangular elevation 3 is extruded integrally with the main body 2.

The formation, illustrated in FIG. 1, of the elevations 3 of triangular cross section on both broad sides of the main body 2 is advantageous because this simplifies the processing of the wickerwork fibre 1 since it is not necessary to pay attention to which side of the wickerwork fibre 1 is oriented towards the surface of the finished product.

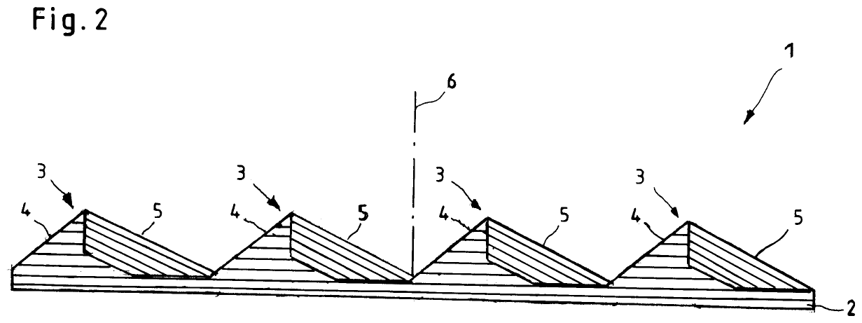

FIG. 2 of the drawing shows an alternative second embodiment for the formation of a wickerwork fibre 1, in which the main body 2 has elevations 3 that run parallel to one another only on one broad side and are triangular in cross section, which are arranged directly adjacent to one another, in parallel, without any intermediate space.

In this embodiment too, the two sides 4 and 5, forming the elevation 3, of each triangular elevation 3 are co-extruded from two separate strands of plastic material, wherein one of the two sides 4, forming the elevation 3, of each triangular elevation 3 is extruded integrally with the main body 2.

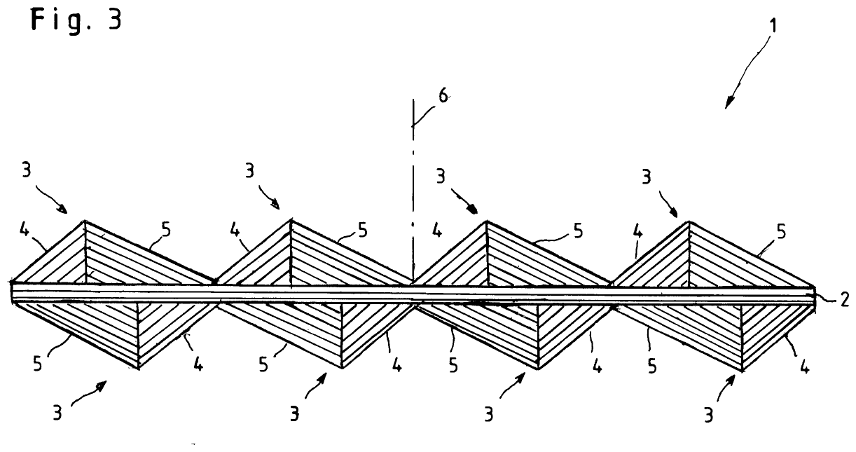

The third embodiment, illustrated in FIG. 3, for the formation of a wickerwork fibre 1 differs from the embodiment shown in FIG. 1 in that the two sides 4 and 5, forming the elevation 3, of each triangular elevation 3 are designed as material strands extruded separately onto the flat main body 2. In contrast to the illustration according to FIG. 1, here no side 4 or 5 is formed integrally with the main body 2.

As an alternative to the embodiments illustrated in FIG. 1 to FIG. 3 of the drawing, all subcombinations of the embodiments illustrated can of course also be produced as wickerwork fibres 1.

The wickerwork fibres 1 designed as described above with the elevations 3 of triangular cross section are distinguished by the fact that they closely resemble a natural fibre in terms of haptic and visual perception and are easy to produce.

The visual impression is particularly advantageous if the material of the two sides 4 and 5 forming the respective triangular elevations 3 are of different colours, in particular complementary colours.

By selecting the length of the two sides 4 and 5 projecting from the flat main body 2, which form the respective triangular elevations 3, the height of the elevations 3 and the angle at which the sides 4 and 5 abut at the tip of the respective triangular elevation 3 can be varied, as a result of which the visual and also the haptic impression that wickerwork fibres 1 produced in this way make on the viewer differs. Depending on the angle of view of the viewer, a different perception of the colour effect occurs, ensuring a harmonious overall impression of the wickerwork fibre 1 and of the end product formed from this wickerwork fibre 1.

### LIST OF REFERENCE SIGNS

1 wickerwork fibre
2 main body
3 elevation
4 side
5 side
6 longitudinal axis

I claim:

1. A wickerwork fibre for the production of furniture and/or furniture parts, comprising:
a main body produced by extrusion and composed of a plastic material with a flat cross section, a width of which is a multiple of a height, and wherein the main body has elevations running parallel to one another at least on one broad side,
wherein the elevations are triangular in cross section.

2. The wickerwork fibre according to claim 1, wherein the triangular elevations are arranged directly adjacent to one another, in parallel, free of any intermediate spaces.

3. The wickerwork fibre according to claim 1, wherein two sides forming the triangular elevations are of different lengths.

4. The wickerwork fibre according to claim 1, wherein two sides forming the triangular elevations are of equal length.

5. The wickerwork fibre according to claim 3, wherein the two sides forming the triangular elevations are of equal length on all elevations arranged adjacent to one another in parallel.

6. The wickerwork fibre according to claim 1, wherein elevations of triangular cross section are formed on two broad sides of the main body.

7. The wickerwork fibre according to claim 1, wherein the triangular elevations run in a longitudinal direction of the wickerwork fibre.

8. The wickerwork fibre according to claim 1, wherein the triangular elevations are arranged at an angle that deviates from a longitudinal direction of the wickerwork fibre.

9. The wickerwork fibre according to claim 1, wherein two sides forming the triangular elevations are formed by co-extruding two strands of plastic material, wherein the two strands of plastic material of the two sides forming the elevation are of different colours.

10. The wickerwork fibre according to claim 1, wherein the triangular elevations are formed by extrusion onto the flat main body.

11. The wickerwork fibre according to claim 1, wherein two sides forming the triangular elevations are formed by co-extruding two strands of plastic material, wherein one of the two sides forming the triangular elevations is formed integrally with the main body.

12. A method for producing a wickerwork fibre according to claim 1, wherein two sides forming the triangular elevations and the main body are produced by co-extrusion,
wherein the two sides forming triangular elevations are co-extruded from two separate strands of plastic material, wherein one of the two sides forming the triangular elevations is extruded integrally with the main body.

13. A method for producing a wickerwork fibre according to claim 1, wherein two sides forming the triangular elevations and the main body are produced by co-extrusion,
wherein the two sides forming the triangular elevations are co-extruded onto the main body from two separate strands of plastic material.
